(19) United States
(12) Patent Application Publication
(10) Pub. No.: US 2021/0354713 A1
(43) Pub. Date: Nov. 18, 2021

(54) AGENT CONTROL DEVICE, AGENT CONTROL METHOD, AND STORAGE MEDIUM STORING AGENT CONTROL PROGRAM

(71) Applicant: TOYOTA JIDOSHA KABUSHIKI KAISHA, Toyota-shi (JP)

(72) Inventor: Kohki TAKESHITA, Tokyo (JP)

(73) Assignee: TOYOTA JIDOSHA KABUSHIKI KAISHA, Toyota-shi (JP)

(21) Appl. No.: 17/319,581

(22) Filed: May 13, 2021

(30) Foreign Application Priority Data
May 18, 2020 (JP) 2020-086992

(51) Int. Cl. B60W 50/14; G10L 15/22

(52) U.S. Cl. CPC B60W 50/14; G10L 15/22; B60W 2050/143; G10L 2015/223; B60W 2540/21

(57) ABSTRACT

An agent control device acquires configuration information relating to a communication mode between a communications device in a vehicle and a plurality of agent servers. The agent control device, on the basis of the acquired configuration information, select one agent server from the plurality of agent servers. The agent control device perform control such that voice message information of an agent corresponding to the selected agent server is output.

### CROSS-REFERENCE TO RELATED APPLICATION

This application is based on and claims priority under 35 USC 119 from Japanese Patent Application No. 2020-86992 filed on May 18, 2020, the disclosure of which is incorporated by reference herein.

### TECHNICAL FIELD

The present disclosure relates to an agent control device, an agent control method and an storage medium storing an agent control program.

### RELATED ART

Heretofore, technology that controls operations of two software agents has been known. For example, Japanese Patent Application Laid-Open (JP-A) No. 2018-189984 discloses a technology that is a voice interaction method for utilizing services from two agents, which determines which of the two agents should respond on the basis of agent information such as keywords identifying the agents and the like.

An agent as disclosed in the above-mentioned JP-A No. 2018-189984 may be available in, for example, a vehicle. When an agent is utilized in a vehicle, the agent interacts by voice messages with a user, and executes processing governed by the content of interactions. The agent outputs the results of execution of the processing governed by the content of the interactions via equipment in the vehicle.

Multiple agents may be available in a vehicle, in which case an agent to be utilized must be selected from the plural agents. When an agent operates at an external server (below referred to as an agent server), communications between the vehicle and the agent server are required.

When plural agents operate at respectively different agent servers, there is a question as to which agent server should be selected. When communications are conducted between a vehicle and plural agent servers, it is necessary to take account of communication mode such as communication speeds, communication fees and the like.

However, the technology in JP-A No. 2018-189984 only discloses that an agent to be operated is selected by a keyword identifying the agent; no consideration is given to a situation in which plural agents are available in a vehicle. Moreover, the technology of JP-A No. 2018-189984 gives no consideration to communication mode between the vehicle and agent servers.

Therefore, when the technology disclosed in JP-A No. 2018-189984 is employed and an available agent is to be selected while a user is riding in a vehicle, it may not be possible to select an agent expeditiously in accordance with communication mode between the vehicle and the agent servers.

### SUMMARY

In consideration of the circumstances described above, the present disclosure provides an agent control device, an agent control method and an agent control program that, when an available agent is to be selected while a user is riding in a vehicle, may expeditiously select an agent in accordance with communication mode between the vehicle and agent servers.

An agent control device according to a first aspect includes: an acquisition section that acquires configuration information relating to communication mode between a communications device in a vehicle and plural agent servers; a selection section that, on the basis of the configuration information acquired by the acquisition section, selects one agent server from the plural agent servers; and a control section that performs control such that voice message information of an agent corresponding to the agent server selected by the selection section is outputted.

The agent control device according to the first aspect acquires the configuration information relating to communication mode between the communications device in the vehicle and the plural agent servers. An agent according to the first aspect is to interact by voice messages with the user and execute processing governed by the content of interactions, and output results of the execution of the processing governed by the content of the interactions via equipment in the vehicle. This agent is manifested by a computer executing a predetermined program. The agent control device then selects one agent server from the plural agent servers on the basis of the acquired configuration information. Hence, the agent control device performs control such that voice message information from the agent corresponding to the selected agent server is outputted. Thus, when an available agent is to be selected while the user is riding in the vehicle, an agent may be expeditiously selected in accordance with communication mode between the vehicle and the agent servers.

In the agent control device according to a second aspect, the configuration information includes priority levels that are specified in advance, the priority levels representing which communication mode are to be prioritized for communications between the communications device in the vehicle and the plurality of agent servers, and the selection section refers to the configuration information acquired by the acquisition section and selects the agent server with a highest priority level. Therefore, an agent may be selected more expeditiously in accordance with priority levels of the communication mode.

In the agent control device according to a third aspect, the selection section, when selecting the one agent server, displays a selection screen of agents corresponding to the agent servers with the highest priority levels and, when an agent displayed at the selection screen is selected by a user, finalizes selection of the agent corresponding to the agent server. Therefore, an agent may be selected more expeditiously with consideration for the intent of the user.

In an agent control method according to a fourth aspect, a computer executes processing including: acquiring configuration information relating to communication mode between a communications device in a vehicle and a plurality of agent servers; on the basis of the acquired configuration information, selecting one agent server from the plurality of agent servers; and performing control such that voice message information of an agent corresponding to the selected agent server is outputted.

An agent control program according to a fifth aspect causes a computer to execute processing including: acquiring configuration information relating to communication mode between a communications device in a vehicle and a plurality of agent servers; on the basis of the acquired configuration information, selecting one agent server from the plurality of agent servers; and performing control such that voice message information of an agent corresponding to the selected agent server is outputted.

According to the present disclosure as described above, an effect is provided in that, when an available agent is to be selected while a user is riding in a vehicle, an agent may be expeditiously selected in accordance with communication mode between the vehicle and agent servers.

### BRIEF DESCRIPTION OF DRAWINGS

FIG. 1 is a descriptive diagram describing an overview of a present exemplary embodiment.

FIG. 2 is a schematic block diagram of an agent control system according to the present exemplary embodiment.

FIG. 3 is a diagram showing a structural example of a computer of an agent control device.

FIG. 4 is a diagram showing an example of configuration information.

FIG. 5 is a flowchart showing an example of processing that is carried out at the agent control device according to the exemplary embodiment.

FIG. 6 is a diagram showing an example of a selection screen displayed at a touch panel.

### DETAILED DESCRIPTION

### Exemplary Embodiment

Below, an agent control system according to the exemplary embodiment is described using the drawings.

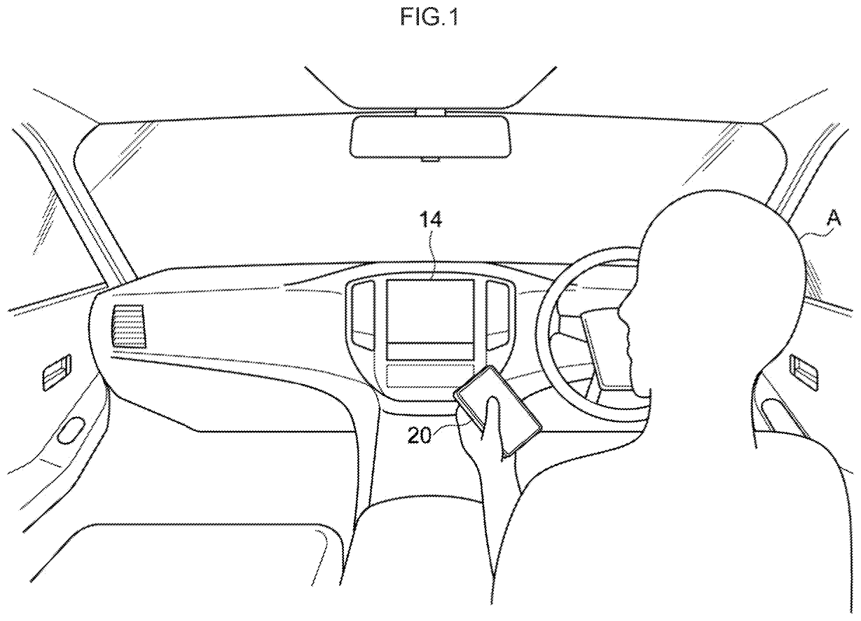

FIG. 1 is a descriptive diagram describing an overview of the present exemplary embodiment. FIG. 1 depicts a situation when a user A is riding in a vehicle. The user A carries a portable terminal 20, which is a smartphone or the like (when safe and permitted, for example, while parked). In FIG. 1, a touch panel 14 is shown as an example of display equipment in the vehicle, at which various kinds of information are displayed. The touch panel 14 and the portable terminal 20 are connected to an agent control device (not shown in the drawing), which is described below.

In the present exemplary embodiment, the user A utilizes an agent that is capable of voice interactions in the vehicle. The agent according to the present exemplary embodiment interacts with the user A by voice messages, and executes processing governed by the content of interactions. The agent outputs results of the execution of the processing governed by the content of the interactions via equipment in the vehicle. The agent according to the present exemplary embodiment is manifested by an agent server (not shown in the drawing), which is described below, executing a predetermined program.

For example, sometimes the user A may want to utilize an agent in the vehicle that is usually utilized through the portable terminal 20. At other times, the user A may want to utilize an agent in the vehicle that is utilized at home. At still other times, the user A may want to utilize an agent in the vehicle that can only be utilized in the vehicle. Thus, one agent to be utilized in the vehicle must be selected from among plural agents.

The plural agents that are available in the vehicle are respectively manifested by plural different agent servers. When communications are conducted between the vehicle and the plural agent servers, communication mode such as communication speeds, communication fees and so forth must be considered.

For example, for an agent that operates through the portable terminal 20, communications between the portable terminal 20 and an external agent server are required. Accordingly, slow communication speeds and high communication fees can be expected. In contrast, between, for example, a dedicated agent server and the vehicle, communication speeds may be fast and communication fees may be inexpensive.

Accordingly, when plural agents are available in a vehicle, an agent control device according to the present exemplary embodiment selects which agent a user is to utilize in the vehicle in accordance with communication mode between the vehicle and agent servers that operate the plural agents. Thus, when plural agents are available in the vehicle, an agent may be selected expeditiously in accordance with communication mode between the vehicle and the agent servers.

This is described in specific terms below.

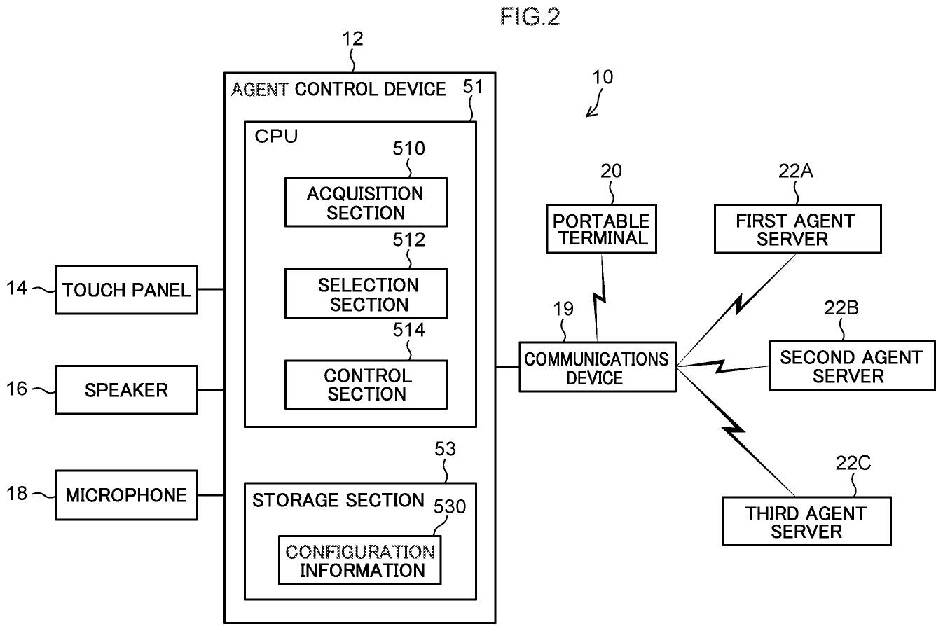

FIG. 2 is a block diagram showing an example of structures of an agent control system 10 according to the exemplary embodiment. As shown in FIG. 2, the agent control system 10 is provided with an agent control device 12, the touch panel 14, a speaker 16, a microphone 18, a communications device 19, the portable terminal 20, a first agent server 22A, a second agent server 22B and a third agent server 22C. The agent control device 12, the touch panel 14, the speaker 16, the microphone 18 and the communications device 19 are disposed in the same vehicle.

—Agent Control Device—

As shown in FIG. 2, the agent control device 12 is provided with a central processing unit (CPU) 51 and a storage section 53.

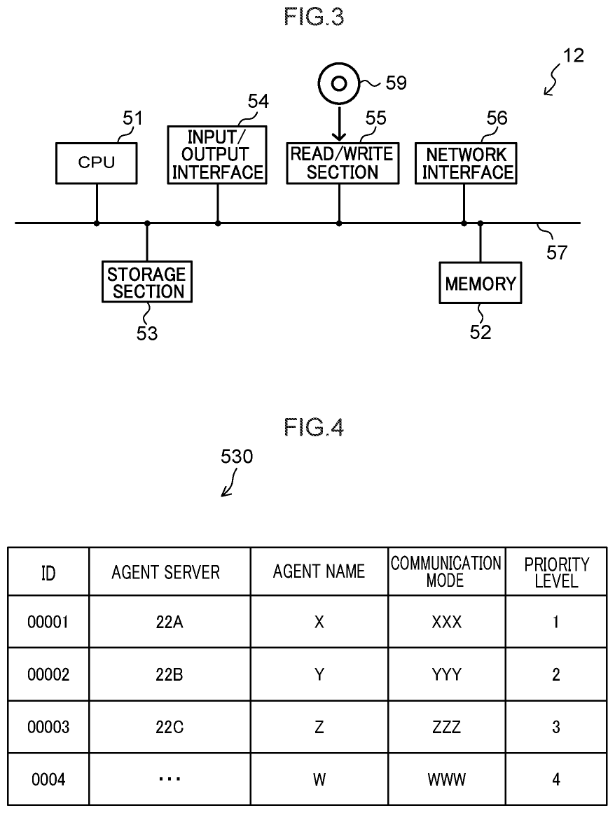

More specifically, the agent control device 12 is realized by, for example, a computer as shown in FIG. 3. The computer that realizes the agent control device 12 is provided with the CPU 51, a memory 52 that serves as a temporary storage area, and the storage section 53 that is nonvolatile. The computer is further provided with an input/output interface 54 that is connected to input/output devices and the like (which are not shown in the drawings) and with a read/write section 55 that controls reading and writing of data at a recording medium 59. The computer is also provided with a network interface 56 that is connected to a network such as the Internet or the like. The CPU 51, memory 52, storage section 53, input/output interface 54, read/write section 55 and network interface 56 are connected to one another via a bus 57.

The storage section 53 may be realized by a hard disk drive (HDD), solid state drive (SSD), flash memory or the like. A program causing the computer as the agent control device 12 to function is stored at the storage section 53 that serves as a storage medium. The CPU 51 reads the program from the storage section 53 and loads the program into the memory 52, and successively executes processes included in the program.

As shown in FIG. 2, in functional terms the CPU 51 of the agent control device 12 provides an acquisition section 510, a selection section 512 and a control section 514. Processing of the acquisition section 510, the selection section 512 and the control section 514 is described below.

As shown in FIG. 2, the storage section 53 of the agent control device 12 also stores configuration information 530. The configuration information 530 is information relating to communication mode between the vehicle and the plural agent servers.

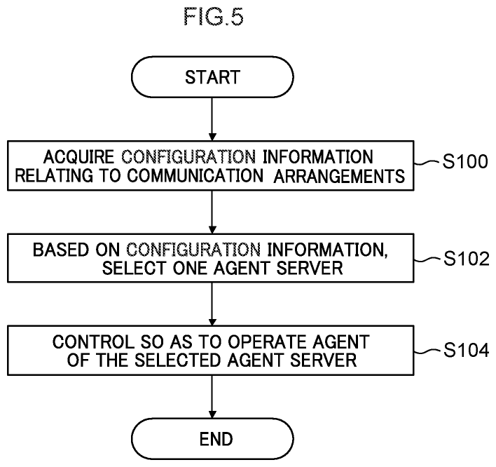

FIG. 4 is a diagram showing an example of the configuration information 530 stored by the storage section 53. The configuration information 530 associates an ID, which is information identifying an agent server, with a name of the corresponding agent server, the name of an agent operated at the agent server, information relating to a communication arrangement between the agent server and the vehicle, and a priority level of the agent server.

The priority levels are information representing which communication mode are to be prioritized for communications between the communications device 19 in the vehicle and the plural agent servers. The smaller the number represented by a priority level, the higher the priority of that agent server for communications with the communications device 19 in the vehicle. The priority levels are specified in accordance with, for example, communication fees and communication speeds. In this example, the priority levels are specified such that faster communication speeds have higher priority levels and lower communication fees have higher priority levels.

For example, when fees relating to a communication arrangement between the communications device 19 and the first agent server 22A are lower than fees relating to a communication arrangement between the communications device 19 and the second agent server 22B, the priority level of the communication arrangement with the first agent server 22A is specified to be higher than the same for the second agent server 22B.

If the user has a particular contract relating to the communication arrangement with the second agent server 22B (for example, if the user has purchased an extra data package or the like for the communication arrangement with the second agent server 22B), the priority level of the communication arrangement with the second agent server 22B can be specified to be higher than for the other agent servers.

A priority level when connecting to an external agent server (not shown in the drawings) via the user's portable terminal 20 may be reflected in the configuration information. For example, when the user utilizes the agent that operates at the portable terminal 20, the portable terminal 20 must use a communications circuit that the portable terminal 20 uses to communicate with the external agent server (not shown in the drawings). In this situation, communication fees are relatively high and the priority level may be specified accordingly.

Each time agent control processing is executed, which is described below, the configuration information 530 is acquired by the acquisition section 510 and saved to the storage section 53.

The touch panel 14 is connected to the agent control device 12 via the input/output interface 54. The touch panel 14 displays arbitrary screens and accepts operation information from the user.

The speaker 16 is connected to the agent control device 12 via the input/output interface 54 and outputs voice messages.

The microphone 18 is connected to the agent control device 12 via the input/output interface 54 and acquires voice messages uttered in the vehicle.

The communications device 19 is connected to the agent control device 12 via the network interface 56. The agent control device 12 exchanges information with the the first agent server 22A, the second agent server 22B and the third agent server 22C via the communications device 19. The communications device 19 is connected with the the first agent server 22A, the second agent server 22B and the third agent server 22C by communications circuits such as, for example, the Internet and the like.

Similarly, the agent control device 12 and the portable terminal 20 exchange information via the communications device 19. The agent control device 12 and the portable terminal 20 are connected by, for example, predetermined short-range communications.

—Agent Servers—

As shown in FIG. 2, the agent control system 10 according to the present exemplary embodiment is provided with the first agent server 22A, the second agent server 22B and the third agent server 22C.

Each of the first agent server 22A, the second agent server 22B and the third agent server 22C is a server that operates an agent. The first agent server 22A, the second agent server 22B and the third agent server 22C manifest the respective agents by executing predetermined programs. In the present exemplary embodiment, an agent X operates at the first agent server 22A, an agent Y operates at the second agent server 22B and an agent Z operates at the third agent server 22C.

—Portable Terminal—

The portable terminal 20 is, for example, a smartphone or the like that is carried and frequently used by a user in the vehicle. The user riding in the vehicle may utilize an agent operating at the portable terminal 20 (when safe and permitted, for example, while parked). An agent W operates at the portable terminal 20 according to the present exemplary embodiment. In practice, the agent W operating at the portable terminal 20 is manifested at the external agent server (not shown in the drawings).

Now, operation of the agent control system 10 according to the exemplary embodiment is described.

When the agent control device 12 receives signals indicating that a user in the vehicle is utilizing an agent, the agent control device 12 executes the agent control processing routine shown in FIG. 5.

For example, when a button (not shown in the drawings) commanding startup of an agent is provided in a vicinity of a steering wheel of the vehicle, the agent control device 12 executes the agent control processing routine when the button is pressed and held by the user to generate agent startup command signals.

In step S100, the acquisition section 510 of the CPU 51 of the agent control device 12 acquires configuration information relating to communication mode between the agent control device 12 of the vehicle and plural agent servers. The acquisition section 510 temporarily saves the configuration information 530 in the storage section 53.

For example, in step S100, the acquisition section 510 acquires the configuration information 530 as illustrated in FIG. 4 and temporarily saves the configuration information 530 to the storage section 53. As an example, the acquisition section 510 acquires the configuration information 530 from respective storage sections (not shown in the drawings) of the portable terminal 20, the first agent server 22A, the second agent server 22B and the third agent server 22C. The acquisition section 510 may acquire the configuration information 530 from other external servers.

In step S102, the selection section 512 of the CPU 51 of the agent control device 12 reads the configuration information 530 saved in the storage section 53 in step S100. Then, on the basis of the configuration information 530, the selection section 512 selects one agent server from the plural agent servers.

For example, the selection section 512 refers to the configuration information 530 and selects the agent server with the highest priority level. In the example of the configuration information 530 in FIG. 4, the first agent server 22A has the highest priority level. Therefore, the selection section 512 selects the first agent server 22A with the highest priority level.

In step S104, the control section 514 performs control such that voice message information from the agent corresponding to the agent server selected in step S102 is outputted.

For example, when the first agent server 22A is selected, the control section 514 sends control signals commanding operation of the agent X at the first agent server 22A to the first agent server 22A via the communications device 19. As a result, the agent X operates at the first agent server 22A, and interaction via the speaker 16 and the microphone 18 between the user in the vehicle and the agent X begins.

As described above, the agent control device 12 of the agent control system 10 according to the present exemplary embodiment acquires configuration information relating to communication mode between a vehicle and plural agent servers. On the basis of the acquired configuration information, the agent control device 12 selects one agent server from the plural agent servers. The agent control device 12 performs control such that voice message information of an agent corresponding to the selected agent server is outputted. Thus, when an available agent is to be selected while a user is riding in the vehicle, an agent may be expeditiously selected in accordance with communication mode between the vehicle and the agent servers.

The processing that is executed by each device according to the exemplary embodiment described above is described as being software processing that is implemented by a program being executed, but the processing may be implemented in hardware. Alternatively, the processing may combine both software and hardware. Further, the programs memorized in storage sections may be memorized in any of various storage media and distributed.

The present disclosure is not limited by the above recitations. In addition to the above recitations, it will be clear that numerous modifications may be embodied within a technical scope not departing from the gist of the disclosure.

For example, when an agent server is to be selected, the selection section 512 of the CPU 51 may display at the touch panel 14 a selection screen of agents corresponding to the agent servers with the highest priority levels in the configuration information 530. When an agent displayed in the selection screen is selected by a user, the selection section 512 may finalize selection of the agent corresponding to the agent server selected by the user.

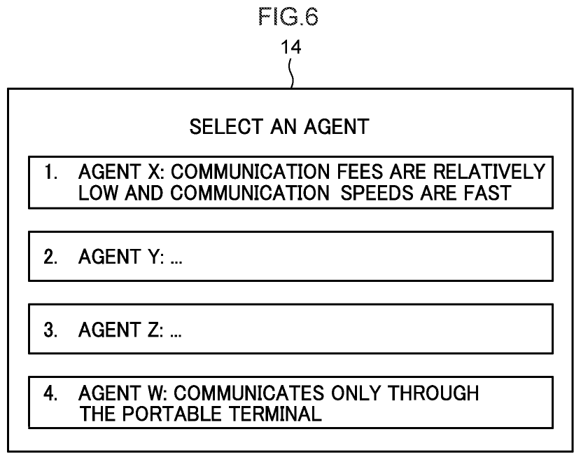

As another example, the selection section 512 of the CPU 51 may display a selection screen as illustrated in FIG. 6 at the touch panel 14 and may select an agent server selected by a user selection. In the example shown in FIG. 6, the priority level of the agent X operating at the first agent server 22A is highest and the priority level of the agent W operating at the portable terminal 20 is lowest. In the example shown in FIG. 6, a list of agents and information relating to the communication mode of the agents are displayed. The user refers to this information and selects an agent to utilize.

All publications, patent applications, and technical standards mentioned in this specification are herein incorporated by reference to the same extent as if each individual publication, patent application, or technical standard was specifically and individually indicated to be incorporated by reference.

What is claimed is:

1. An agent control device, comprising:
a memory; and
a processor connected to the memory, the processor being configured to:
acquire configuration information relating to a communication mode between a communications device in a vehicle and a plurality of agent servers,
on the basis of the acquired configuration information, select one agent server from the plurality of agent servers, and
perform control such that voice message information of an agent corresponding to the selected agent server is output.

2. The agent control device according to claim 1, wherein:
the configuration information includes priority levels that are set in advance, the priority levels representing which communication mode is to be prioritized for communications between the communications device in the vehicle and the plurality of agent servers, and
the processor is configured to refer to the acquired configuration information and select the agent server with a highest priority level.

3. The agent control device according to claim 2, wherein, when selecting the one agent server, the processor is configured to:
display a selection screen of agents corresponding to the agent servers with the highest priority level and,
when an agent displayed at the selection screen is selected by a user, finalize selection of the agent corresponding to the one agent server.

4. An agent control method comprising executing processing by a processor, the processing comprising:
acquiring configuration information relating to a communication mode between a communications device in a vehicle and a plurality of agent servers;
on the basis of the acquired configuration information, selecting one agent server from the plurality of agent servers; and
performing control such that voice message information of an agent corresponding to the selected agent server is output.

5. A non-transitory computer readable storage medium storing an agent control program executable by a processor to perform processing comprising:
acquiring configuration information relating to a communication mode between a communications device in a vehicle and a plurality of agent servers;
on the basis of the acquired configuration information, selecting one agent server from the plurality of agent servers; and
performing control such that voice message information of an agent corresponding to the selected agent server is output.
